(19) United States
(12) Patent Application Publication
(10) Pub. No.: US 2025/0222932 A1
(43) Pub. Date: Jul. 10, 2025

(54) TRAVELLING CONTROL APPARATUS OF VEHICLE

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Takahiro NARITA, Tokyo (JP); Riku KOYAMA, Tokyo (JP); Hideki KAMATANI, Susono-shi, Shizuoka-ken (JP)

(21) Appl. No.: 19/012,490

(22) Filed: Jan. 7, 2025

(30) Foreign Application Priority Data
Jan. 9, 2024 (JP) 2024-001146

(51) Int. Cl. B60W 30/182; B60W 30/165; B60W 30/18; B60W 40/13

(52) U.S. Cl. CPC B60W 30/182; B60W 30/165; B60W 30/18072; B60W 40/13; B60W 2520/105; B60W 2530/10; B60W 2552/15; B60W 2554/802

(57) ABSTRACT

A travelling control apparatus changes a traveling mode between a pulse mode and a coasting mode. A slope calculation unit is configured to calculate a pulse acceleration as an acceleration of the own vehicle when assuming that the pulse mode is executed, and a glide acceleration as an acceleration of the own vehicle when assuming that the coasting mode is executed. The travelling control apparatus is configured to, when assuming that the coasting mode starts to be executed from a current time during the pulse mode, change the travelling mode to the coasting mode from the pulse mode, under a condition determined that the intervehicle distance is shorter than a predetermined target intervehicle distance at a speed coincidence point where a preceding vehicle speed as a travelling speed of the preceding vehicle coincides with the own vehicle speed.

### CROSS-REFERENCE TO RELATED APPLICATION

This application is based on and claims the benefit of priority from earlier Japanese Patent Application No. 2024-1146 filed Jan. 9, 2024, the description of which is incorporated herein by reference.

### BACKGROUND

### Technical Filed

The present disclosure relates to a travelling control apparatus that causes an own vehicle to perform a following travel for following a preceding vehicle.

### Description of the Related Art

As a conventional art, for example, a travelling control apparatus is known in which a first control mode, a second control mode and a third control mode are present for controlling an own vehicle. Specifically, in the first control mode, a driving force of the own vehicle is controlled such that an intervehicle distance between the own vehicle and a preceding vehicle is a predetermined distance, in the second control mode, the engine is stopped and the clutch mechanism is disengaged, thereby causing the own vehicle to perform a coasting travel, and in the third control mode, the engine is operated at an operation point in a region indicative of an optimal fuel consumption.

### SUMMARY

As a first aspect of the present disclosure, a travelling control apparatus is provided which is installed in an own vehicle provided with an engine, a driving wheel and a transmission intercepting mechanism that transmits and cuts off a driving force between the engine and the driving wheel, causing the own vehicle to follow a preceding vehicle,
wherein the own vehicle includes:
an own vehicle speed detection unit that detects an own vehicle speed as a travelling speed of the own vehicle;
a relative speed detection unit that detects a relative speed between the preceding vehicle and the own vehicle;
a distance detection unit that detects an intervehicle distance between the preceding vehicle and the own vehicle;
a slope calculation unit that calculates a slope of a travelling road on which the own vehicle travels; and
an engine ECU that controls the engine.

The travelling control apparatus is configured to execute a travelling mode between a pulse mode and a coasting mode, the pulse mode operating the engine at a predetermined operation region where a heat efficiency is the highest to cause the own vehicle to travel, the coasting mode stopping the engine to cause the own vehicle to perform a coasting travel in a state where the transmission intercepting mechanism cuts off the driving force;
the engine ECU is configured to calculate an output of the engine in accordance with a known characteristics of the engine and a current operation state of the engine;
the slope calculation unit is configured to calculate, in accordance with the output of the engine calculated by the engine ECU, a known weight of the own vehicle and the calculated slope, a pulse acceleration as an acceleration of the own vehicle when assuming that the pulse mode is executed and a glide acceleration as an acceleration of the own vehicle when assuming that the coasting mode is executed;
the travelling control apparatus is configured to acquire the own vehicle speed detected by the own vehicle speed detection unit, the relative speed detected by the relative speed detection unit, the intervehicle distance detected by the distance detection unit, the pulse acceleration and the glide acceleration which are calculated by the slope calculation unit; and
the travelling control apparatus is configured to, when assuming that the coasting mode starts to be executed from a current time during the pulse mode, change the travelling mode to the coasting mode from the pulse mode, under a condition determined that the intervehicle distance is shorter than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired glide acceleration and a preceding vehicle acceleration as an acceleration of the preceding vehicle which is acquired or calculated.

### BRIEF DESCRIPTION OF THE DRAWINGS

In the accompanying drawings:

FIG. 1 is a block diagram showing a configuration of a vehicle;

FIG. 2 is a characteristic diagram showing a relationship between an engine rotation speed, an engine torque and an engine heat efficiency;

FIG. 3 is a schematic diagram showing a coasting mode start condition;

FIG. 4 is a graph showing a relationship between a current relative speed and a future target differential-intervehicle-distance at which a preceding vehicle speed and an own vehicle speed is the same, when assuming that the coasting mode is executed;

FIG. 5 is a schematic diagram showing a start condition of a pulse mode; and

FIG. 6 is a graph showing a relationship between a current relative speed and a future target differential-intervehicle-distance at which a preceding vehicle speed and an own vehicle speed is the same, when assuming that the pulse mode is executed.

### DETAILED DESCRIPTION OF THE PREFERRED EMBODIMENTS

As a conventional art, for example, JP-A-2018-134925 discloses a travelling control apparatus in which a first control mode, a second control mode and a third control mode are present for controlling an own vehicle. Specifically, in the first control mode, a driving force of the own vehicle is controlled such that an intervehicle distance between the own vehicle and a preceding vehicle is a predetermined distance, in the second control mode, the engine is stopped and the clutch mechanism is opened, thereby causing the own vehicle to perform a coasting travel, and in the third control mode, the engine is operated at an operation point in a region indicative of an optimal fuel consumption. According to the above-described travelling control apparatus, a determination boundary line that divides respective regions corresponding to the first to third control modes is set in a map of which the horizontal axis indicates a relative speed between the own vehicle and the preceding vehicle with respect to the own vehicle and the vertical axis indicates a relative distance between the own vehicle and the preceding vehicle with respect to the own vehicle. Then, the control mode is changed in the case where the current travelling state of the own vehicle which is determined by the relative speed and the relative distance exceeds the determination boundary line.

According to the above-described travelling control apparatus, in order to appropriately changing the control mode among the first to third control modes, the determination boundary line is required to be appropriately set in advance. Moreover, in order to set the determination boundary line, it is necessary to consider a relationship between acceleration factors presumed in the second control mode and the third control mode, and a change in the relative speed and the relative distance. However, since the acceleration factors in the second control mode and the third control mode change depending on characteristics of the engine, characteristics of the transmission, a vehicle weight, a road grade, an air resistance of the vehicle and the like, it is difficult to predict them and is time-consuming prediction. Moreover, it is difficult to appropriately set the determination boundary line in advance and is time-consuming.

Hereinafter, with reference to the drawings, an embodiment will be described in which a travelling control apparatus mounted on a vehicle is embodied. The vehicle refers to a car having an engine as a driving source, a hybrid vehicle having an engine and a motor as driving sources or the like. Note that a vehicle as an object of the present embodiment is referred to as an own vehicle and a vehicle preceding the own vehicle is referred to as a preceding vehicle.

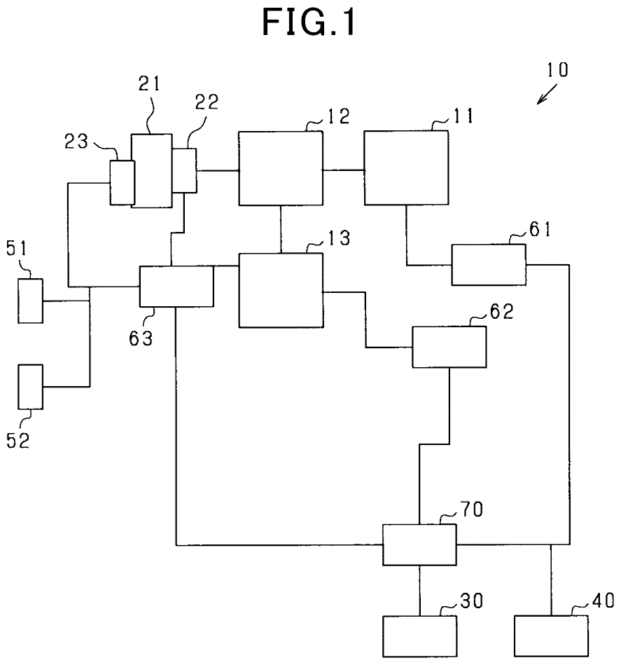

Firstly, with reference to FIG. 1, a configuration of an own vehicle 10 which is controlled by a travelling control apparatus 70 in the present embodiment will be described. FIG. 1 shows a configuration of a hybrid vehicle provided with a drive/brake system including an engine 11 (i.e. internal combustion engine), a motor 13, a power transmission intercepting mechanism 12 and a brake 22.

In the own vehicle 10, the engine 11 is provided as a driving source and the transmission intercepting mechanism 12 is connected to an output side of the engine 11. The transmission intercepting mechanism 12 is configured of a planetary gear mechanism that changes a transmission gear ratio, transmits and cuts off the driving force, or configured of a transmission that changes a transmission gear ratio and a clutch mechanism that transmits and cuts off the driving force.

In the own vehicle 10, the motor 13 is provided as a driving source and the transmission intercepting mechanism 12 is connected to an output side of the motor 13. The motor 13 is configured as a three-phase motor for example, and is driven with a power supplied from a secondary battery (i.e. power source) which is not shown via an inverter (i.e. power conversion unit). The motor ECU (electronic control unit) 62 controls the inverter, thereby controlling the output torque of the motor 13. The motor ECU 62 is configured of, for example, a microprocessor including CPU, ROM, RAM, input-output interface and the like. Note that other ECUs are also provided with configuration similar to the motor ECU 62.

The type of the engine 11 may be a gasoline engine in which a port injection or a cylinder injection is utilized or may be a diesel engine, as long as they are driving sources for driving the own vehicle 11. Moreover, for the structure of the engine 11, a Wankel type rotary engine other than a reciprocating engine may be utilized. The engine 11 includes a crank shaft which is now shown. A crank angle as a rotation angle of the crank shaft is detected by a crank angle sensor which is not shown. An engine ECU 61 (engine control apparatus) calculates a rotation speed of the engine 11 based on the crank angle detected by the crank angle sensor.

Although illustration is omitted, an electronically controlled throttle valve is disposed in the intake passage of the engine 11. The engine ECU 61 calculates an optimized throttle opening in accordance with an acceleration pedal signal that detects a pedal-step-in amount of the acceleration pedal and signals transmitted from respective sensors, and outputs the calculated throttle opening to the throttle valve. Thus, the throttle valve is controlled to be an optimized throttle valve opening. The engine 11 performs combustion of a fuel in a cylinder (i.e. combustion chamber) to generate a driving force. The driving force of the engine 11 is transmitted to the transmission intercepting mechanism 12. The engine ECU 61 controls an amount of fuel injected into the cylinder of the engine 11 (amount of suction air into the cylinder) and an ignition timing of the air-fuel mixture, thereby controlling the output torque and the rotation speed of the engine 11.

The engine ECU 61 determines appropriate transmission gear ratio based on engine operation information (e.g. an engine rotation speed, a travelling speed and a throttle opening) for operating the engine 11, and a range position of a gear shift lever which is not shown, thereby causing the transmission intercepting mechanism 12 to change the speed. Thus, the transmission intercepting mechanism 12 is controlled to be in an optimized transmission gear ratio. Note that the own vehicle 10 may be provided with a transmission ECU that controls the transmission intercepting mechanism 12.

When transmitting the driving force from the engine 11 and/or the motor 13 to the driving wheels 21, the transmission intercepting mechanism 12 is connected, and when intercepting the driving wheels 21 from the engine 11 and the motor 13, the transmission intercepting mechanism 12 is disconnected.

The brake 22 applies a braking force to the driving wheels 21 based on a pedal force of the brake pedal which is not shown. A wheel speed sensor 23 (own vehicle speed detection unit) detects a rotation angle and a rotation speed of the driving wheel 21. An acceleration sensor 51 detects an own vehicle acceleration As as an acceleration factor of the own vehicle 10. The brake ECU 63 (slope calculation unit) calculates an own vehicle speed Vs based on the rotation speed detected by the wheel speed sensor 23 and combines the calculated own vehicle speed Vs with the own vehicle acceleration As detected by the acceleration sensor 51, thereby calculating the slope of the road (travelling road). The brake ECU 63 executes a hill-start assistance that prevents the vehicle from moving backward when starting on a hill-climbing road (road having a rising slope) and controls the braking force to be applied to the driving wheels 21 by the brake 22. Note that the brake ECU 63 may be provided with an ABS (anti-lock braking system) function that prevents tires from being locked (tire lock prevention) when braking operation, a TCS (traction control system) that prevents wheels from losing traction on the road (i.e. wheel spin) when accelerating operation, an ESC (electronic stability control) function that prevents the vehicle from being laterally slipped when vehicle is turning, and the like. In this case, in order to achieve these functions, the brake ECU 63 is capable detecting a road surface property of a road surface of the travelling road 2.

An external field information detection apparatus 30 is configured of a millimeter wave radar apparatus, a laser radar apparatus, a camera and the like. The external field information detection apparatus 30 (distance detection unit) detects an intervehicle distance D which is a distance between the own vehicle 10 and the preceding vehicle. The external field information detection apparatus 30 (relative speed detection unit) divides an amount of change in the detected intervehicle distance D by a time of the change or differentiates the intervehicle distance D, thereby detecting (calculating) a relative speed Vr between the preceding vehicle and the own vehicle 10. Alternatively, the external field information detection apparatus 30 (relative speed detection unit) utilizes Doppler effect so as to directly detect the relative speed Vr. The relative speed Vr between the preceding vehicle and the own vehicle 10 refers to a speed where the own vehicle speed Vs of the own vehicle 10 is subtracted from a preceding vehicle speed Va as a speed of the preceding vehicle (i.e. Vr=Va−Vs). The intervehicle distance D and the relative speed Vr (external field information) detected by the external field information detection apparatus 30 are transmitted to the travelling control apparatus 70.

The intervehicle communication apparatus 40 (communication means), when communication with the preceding vehicle (other vehicle) is available, communicates with the preceding vehicle so as to exchange (transmit/receive) information therebetween. The information includes, for example, a preceding vehicle speed Va, a preceding vehicle acceleration Aa as an acceleration factor of the preceding vehicle and the like. The preceding vehicle acceleration Aa is calculated based on the preceding vehicle speed Va detected by a wheel speed sensor included in the preceding vehicle, or is detected by an acceleration sensor included in the preceding vehicle. The accuracy of the preceding vehicle acceleration Aa thus calculated or detected is higher than that of the preceding vehicle acceleration Aa calculated based on the intervehicle distance D detected by the external field information detection apparatus 30.

The engine ECU 61, the motor ECU 62, the brake ECU 63 and the intervehicle communication apparatus 40 are mutually connected by a communication line and exchange information therebetween. The travelling control apparatus 70 performs communication with the engine ECU 61 to exchange engine control information and transmission control information and utilizes external field recognition information from the external field information detection apparatus 30, thereby causing the own vehicle 10 to follow the preceding vehicle. Further, the travelling control apparatus 70 causes the own vehicle 10 to travel at a predetermined set vehicle speed.

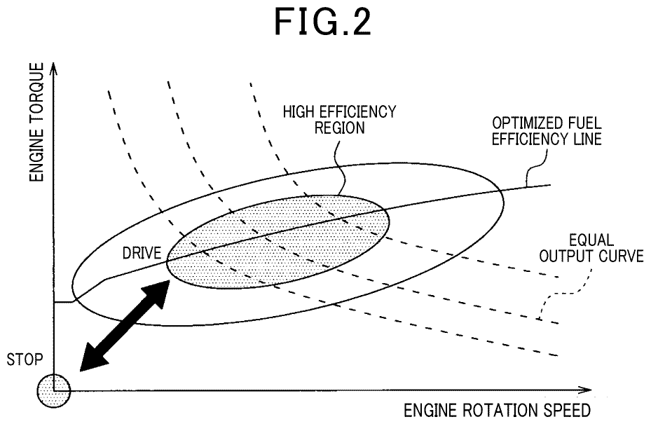

FIG. 2 is an explanatory diagram showing an operating point of the engine 11. Specifically, FIG. 2 is a map indicating an optimal fuel consumption line and a high efficiency region based on an engine characteristics map where the vertical axis is an engine rotation speed and the horizontal axis is an engine torque.

The travelling control apparatus 70 controls the engine 11 to operate in a high efficiency region where the heat efficiency of the engine 11 is high, thereby causing the own vehicle 10 travels in a pulse mode. In the pulse mode, the engine ECU 61 controls the engine rotation speed, the engine torque, the engine output and the transmission ratio such that the operating point is in the high efficiency region (predetermined operation region where the heat efficiency is the highest) shown in FIG. 2.

Further, the travelling control apparatus 70 stops the engine 11 and performs a coasting mode in which the own vehicle 10 is caused to perform a coasting travel in a state where the driving force is cutoff by the transmission intercepting mechanism 12. In the coasting mode, since the engine 11 is stopped, the operating point is moved to the origin in FIG. 2. Hence, no fuel is consumed, whereby best fuel consumption is accomplished.

The traveling control apparatus 70 switches the mode between the pulse mode and the coasting mode and executes the mode. In the pulse mode, normally, the own vehicle 10 approaches another vehicle. In the coasting mode, normally, the own vehicle recedes from another vehicle. Accordingly, the travelling control apparatus 70 switches the mode between the pulse mode and the coasting mode and executes the mode, whereby the own vehicle 10 can be caused to travel with best fuel consumption, following the preceding vehicle such that the intervehicle distance D is within a predetermined range with respect to a predetermined target intervehicle distance THd. The target intervehicle distance THd refers to a distance where the target intervehicle time THt is multiplied by the own vehicle Vs (THd=THt*Vs). The target intervehicle time THt is set to be a constant value which is determined in advance for example. That is, the target intervehicle time THt is a time where the target intervehicle distance THd which is proportional to the own vehicle Vs (the higher the own vehicle speed Vs, the longer the target intervehicle time Tht is) is divided by the own vehicle speed Vs (i.e. THt=THd/Vs).

Note that the travelling control apparatus 70 executes a normal ACC (auto cruise control) mode in the case where the intervehicle distance D is outside the predetermined range with respect to the target intervehicle distance THd only with the pulse mode and the coasting mode. In the normal ACC mode, the engine ECU 61 controls, regardless of the heat efficiency of the engine 11, the engine rotation speed, the engine torque, the engine output and the transmission ratio such that the intervehicle distance D is the same as the target intervehicle distance THd. Moreover, the travelling control apparatus 70 causes the brake ECU 63 to control a braking force applied to the driving wheels 21. As a case where the intervehicle distance D is outside the predetermined range, for example, when travelling on a descending road having a steep slope, the own vehicle 10 accelerates in both the pulse mode and the coasting mode and if the preceding vehicle is travelling at a constant vehicle speed, it is possible that the own vehicle 10 approaches the preceding vehicle exceeding the predetermined range from the target intervehicle distance THd or even collides with the preceding vehicle.

The engine ECU 61 controls the rotation speed and the output torque of the engine 11 in the pulse mode and the normal ACC mode. Hence, the engine ECU 61 recognizes the current rotation speed and the output torque (i.e. current operation state), the current transmission ratio (i.e. current transmission state) of the transmission of the transmission intercepting mechanism 12 and the like. Further, in order to appropriately execute the pulse mode, the engine ECU 61 has information about the characteristics of the engine 11, the characteristics of the transmission intercepting mechanism 12 (transmission ratio of the transmission) and the vehicle weight of the own vehicle 10. Therefore, the engine ECU 61 is able to calculate the engine power (power, unit: kW) assuming that the pulse mode is executed, based on the known characteristics of the engine 11, the known characteristics of the transmission intercepting mechanism 12, the current operation state of the engine 11 and the current transmission state of the transmission intercepting mechanism 12. The engine output to be calculated is successively updated at every control period during which the engine ECU 61 executes the control. Then, the brake ECU 63 estimates the current control value in accordance with data stored in time series including a change in the wheel speed responding to the engine output, the detection value of the acceleration sensor 51, the current total vehicle weight taking the number of passengers and load capacity into consideration in accordance with the weight value estimated in the design process in advance, an amount of road surface resistance and the degree of slope. Also, the brake ECU 61 combines the estimated current control value with the engine output during the pulse mode calculated by the engine ECU 61, thereby calculating the pulse acceleration Ap accomplished by the own vehicle 10 during the pulse mode. Moreover, the engine output is assumed to be 0, thereby calculating the glide acceleration Ag accomplished by the own vehicle 10 during the coasting mode.

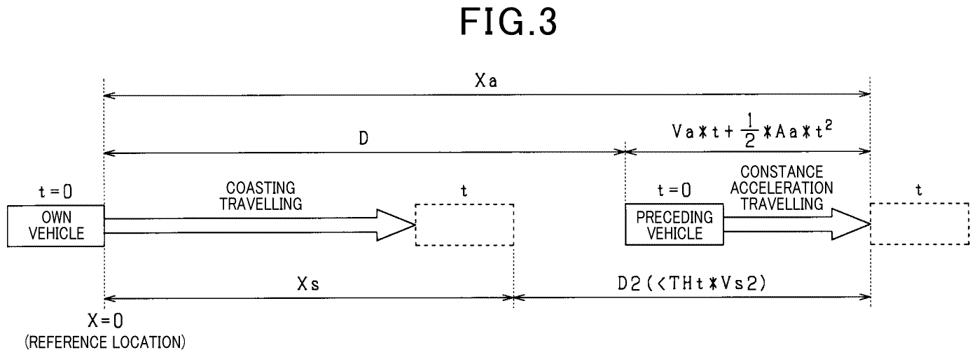

FIG. 3 is a schematic diagram showing a coasting mode start condition. In FIG. 3, at time t=0, the front end part of the own vehicle 10 is located at the distance X=0 as a reference location, and the own vehicle speed Vs, an own vehicle acceleration As, a preceding vehicle speed Va, a preceding vehicle acceleration Aa, and an intervehicle distance D as a distance between the front end of the own vehicle 10 and the rear end of the preceding vehicle are defined.

At time t, the distance Xs from the reference position (X=0) to the front end part of the own vehicle 10 is expressed by the following equation (1). Here, it is assumed that the own vehicle acceleration As (glide acceleration Ag) is constant.

$$Xs = 0 + Vs * t + ( 1 / 2 ) * As * {t}^{2} \qquad ( 1 )$$

At time t, the distance Xa from the reference location to the rear end part of the preceding vehicle is expressed by the following equation (2). Here, it is assumed that the preceding vehicle travels as a constant acceleration travel in which the preceding acceleration Aa is constant.

$$Xa = D + Va * t + ( 1 / 2 ) * Aa * {t}^{2} \qquad ( 2 )$$

For example, in the case where the pulse mode is executed, a state is assumed that the intervehicle distance D is longer than the target intervehicle distance THd (=THt*Vs) and the own vehicle speed Vs is higher than the preceding vehicle speed Va. In the case where a time for continuously executing the pulse mode from the above-described state is excessively long, there is a risk that the intervehicle distance D is shorter than the target intervehicle distance THd and the own vehicle speed Vs is excessively higher than the preceding vehicle speed Va. Therefore, appropriate time point for changing the mode from the pulse mode to the coasting mode may be present prior to the period corresponding to the above-described state.

In this respect, the travelling control apparatus 70 determines a switch condition for switching the mode from the pulse mode to the coasting mode. The switch condition is satisfied in the case where the intervehicle distance D2 is shorter than the target intervehicle distance THt*Vs2 at a coincide time (time t) where the preceding vehicle speed Va2 coincides with the own vehicle speed Vs2, when assuming that the coasting mode is executed from the current time point (t=0) during the pulse mode.

The preceding vehicle speed Va2 at the time t is expressed by the following equation (3).

$$Va 2 = Va + Aa * t \qquad ( 3 )$$

The own vehicle speed Vs at time t is expressed by the following equation (4).

$$Vs 2 = Vs + As * t \qquad ( 4 )$$

The intervehicle distance D2 at time t is expressed by the following equation (5).

$$D 2 = Xa - Xa \qquad ( 5 )$$

Therefore, the above-described condition for switching the mode from the pulse mode to the coasting mode is expressed by the following an inequality (6).

$$THt * Vs 2 > D 2 \qquad ( 6 )$$

Since Va2=Vs2 at time t, the following equation (7) is satisfied by the equations (3) and (4).

$$Va + Aa * t = Vs + As * t \qquad ( 7 )$$

$$t = ( Vs - Va ) / ( Aa - As ) \qquad ( 8 )$$

When substituting the equations (4), (5), (2) and (1) in the inequality (6) and arranging the inequality using the relative speed Vr=(Va−Vs) at the current time t=0, the following inequality (9) is obtained.

$$THt * \{ Vs - As * Vr / ( Aa - As ) \} > D - ( 1 / 2 ) + {Vr}^{2} / ( Aa - As ) \qquad ( 9 )$$

In the in equality (9), when arranging the inequality using Y=(left side)−(right side), the following inequality (10) is obtained.

$$Y = a * {Vr}^{2} + b * Vr + c > 0 \qquad ( 10 )$$

In the inequality (10), a=(½)/(Aa−As), b=THt*{−Aa/(Aa−As)−1}, c=THt*Va−D. Here, it is assumed that the own vehicle acceleration As and the preceding vehicle acceleration Aa are constant, since the target intervehicle time THt is constant, and the preceding vehicle speed Va and the intervehicle distance D are detection values detected at time t=0, coefficient a, b and c can be regarded as constant value (constant). Accordingly, Y in the inequality (Y) can be regarded as a quadratic function of the relative speed Vr at the current time t=0. With the equation (6), Y refers to a difference between the target intervehicle distance THt*Vs2 and the intervehicle distance D2, expressing a future target intervehicle distance difference.

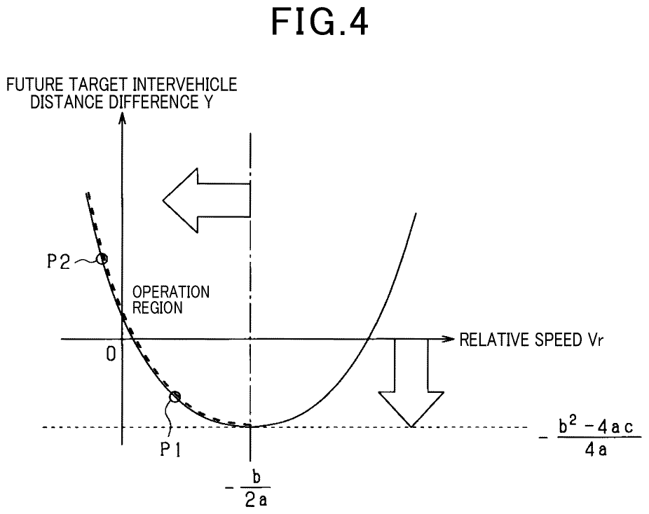

FIG. 4 is a graph showing Y where the horizontal axis is a relative speed Vr at the current time t=0, and the vertical axis is a future target intervehicle distance difference Y. The Y graph expresses a change in the future target intervehicle distance difference Y with respect to the current relative speed Vr when the preceding vehicle speed Va2 coincides with the own vehicle speed Vs2 after time t elapses. Hence, when the inequality (10) is satisfied for the current relative speed Vr, it should be a time for switching the mode from the pulse mode to the coasting mode. For example, when the current traveling state of the own vehicle 10 is at point P1, since the inequality (10) is not satisfied, the pulse mode is continued to execute. On the other hand, when the current traveling state of the own vehicle 10 is at point P2, since the inequality (10) is satisfied, the mode is changed to the coasting mode from the pulse mode. Specifically, when assuming that the coasting mode will be executed from the current time during the pulse mode being executed, under a condition where the intervehicle distance D2 is determined, in accordance with the own vehicle speed Vs, the relative speed Vr, the intervehicle distance D, the own vehicle acceleration As (glide acceleration Ag) and the preceding vehicle acceleration Aa, to be shorter than the target intervehicle distance THt*Vs2 (future target intervehicle distance difference Y>0) at a time t (speed coincidence point) where the preceding vehicle speed Va2 coincides with the own vehicle speed Vs2, the travelling control apparatus 70 switches the traveling mode from the pulse mode to the coasting mode.

At current time t=0, respective parameters are obtained in the following manner. The own vehicle speed Vs is detected based on the rotation angle of the driving wheels 21 detected by the wheel speed sensor 23. The intervehicle distance D is detected by the external field information detection apparatus 30. For the relative speed Vr, an amount of change in the intervehicle distance D detected by the external field information detection apparatus 30 is divided by a change time, or the intervehicle distance is differentiated, thereby detecting (calculating) the relative speed Vr. The own vehicle acceleration As in the pulse mode and the coasting mode (pulse acceleration Ap, glide acceleration Ag) are calculated by the brake ECU 63. The traveling control apparatus 70 receives (acquires) the own vehicle speed Vs, the intervehicle distance D, the relative speed Vr, the pulse acceleration Ap and the glide acceleration Ag via a communication. For the preceding vehicle acceleration Aa, an amount of change in the preceding vehicle speed Va where the relative speed Vr is added to the own vehicle Vs, is divided by a change time, or the preceding vehicle speed Va is differentiated, thereby detecting (calculating) the preceding vehicle acceleration) by the travelling control apparatus 70.

In the case where the preceding vehicle acceleration Aa is calculated based on the relative speed Vr acquired in accordance with the differential value of the intervehicle distance D detected by the external field information detection apparatus 30, there is a risk that the accuracy of the preceding vehicle acceleration Aa may be lowered. In this case, when determining the mode change using a low-accuracy preceding vehicle acceleration Aa, the mode may not be changed between the pulse mode and the coasting mode at an appropriate timing. On the other hand, generally, when causing the own vehicle 10 to follow the preceding vehicle, the preceding vehicle and the own vehicle 10 may often travels on an express way or a major road having less signals. In this case, since the preceding vehicle likely to travel at a constant speed, when determining the preceding vehicle acceleration Aa to be 0 rather than calculating the preceding vehicle acceleration Aa based on the relative speed Vr acquired in accordance with the differential value of the intervehicle distance D, the accuracy of the preceding vehicle acceleration Aa may be higher. For this reason, the travelling control apparatus 70 determines whether the inequality (10) with the preceding vehicle acceleration Aa=0 is satisfied.

However, in order to determine whether a determination whether the mode is changed to the coasting mode from the pulse mode using the inequality (10) is appropriate for assumed traveling states of the own vehicle 10 and the preceding vehicle, a precondition is further added which is a condition that the following inequalities (11) and (12) are satisfied.

$$Aa - As > 0 \qquad ( 11 )$$

The inequality (11) refers to the own vehicle acceleration As in the coasting mode (i.e. glide acceleration Ag) being smaller than the preceding vehicle acceleration Aa. When the inequality (11) is not satisfied, since the own vehicle speed Vs2 does not approach the preceding vehicle speed Va2 even if the coasting mode operation is executed (the own vehicle speed Vs2 does not decrease to the preceding vehicle speed Va2), this is inappropriate for the assumed traveling states of the own vehicle 10 and the preceding vehicle. Hence, in this case, the determination whether the mode is changed to the coasting mode from the pulse mode using the inequality (10) is not performed. Alternatively, it is determined that a condition for changing the mode from the pulse mode to the coasting mode is not satisfied. Since a case where the inequality (11) is satisfied equals a case where a coefficient a=(½)/(Aa−As) is positive, the graph shown in FIG. 4 has a convex shape downwardly.

$$- b / 2 a > Vr \qquad ( 12 )$$

Referring to the graph showing the future target intervehicle distance difference Y, the inequality (12) indicates that the relative speed Vr is in an operation region positioned in the left side with respect to the center axis of the graph. That is, when the relative speed Vr is in a right side in the graph with respect to the center axis of the graph, the higher the relative speed Vr (the higher the preceding vehicle speed Va than the own vehicle speed Vs), the larger the future target distance difference Y is (the intervehicle distance D2 becomes shorter than the target intervehicle distance THt*Vs2). Hence, this is inappropriate for the assumed traveling states of the own vehicle 10 and the preceding vehicle. Accordingly, in this case, the determination using the inequality (10) whether the mode is changed to the coasting mode from the pulse mode is not performed. Alternatively, it is determined that a condition for changing the mode from the pulse mode to the coasting mode is not satisfied.

When substituting a coefficient a=(½)/(Aa−As) and a coefficient b=THt*{−Aa/(Aa−As)−1} in the inequality (12) and arranging the inequality, the following inequality (13) is obtained.

$$THt * Aa > Vr \qquad ( 13 )$$

In a state where the pulse mode and the coasting mode are executed, the preceding vehicle acceleration Aa is often close to 0. Hence, the inequality (13) indicates that the current relative speed Vr is a negative value. Assuming that the pulse mode is executed before changing the mode to the coasting mode, in the case where the inequality (13) is satisfied, it is appropriate for the assumed traveling states of the own vehicle 10 and the preceding vehicle. That is, when the pulse mode is executed before changing the mode to the coasting mode, the inequality (13) is usually satisfied. Therefore, the inequality (12) as a precondition, that is, the inequality (13) as a precondition can be omitted.

Note that, in order to determine whether a determination whether the mode is changed to the coasting mode from the pulse mode using the inequality (10) is appropriate for the assumed traveling states of the own vehicle 10 and the preceding vehicle, a precondition may be further added which is a condition that the following inequality (14) is satisfied.

$$- ( {b}^{2} - 4 a * c ) / 4 a < 0 \qquad ( 14 )$$

The inequality (14) indicates that the apex of the future target intervehicle distance difference Y plot in the graph is a negative value. In the case where the further target intervehicle distance difference Y plot in the graph has a convex shape downwardly and the apex of the plot in the graph has positive value, the future target intervehicle distance difference Y is positive value (the intervehicle distance D2 is shorter than the target intervehicle distance THt*Vs2) regardless of a magnitude of the current relative speed Vr. In this case, the pulse mode operation has not been executed (not continued to execute till the current time). Hence, this is inappropriate for the assumed traveling states of the own vehicle 10 and the preceding vehicle. In other words, when the pulse mode operation is executed before changing the mode to the coasting mode, the inequality (14) is usually satisfied. Therefore, the inequality (14) as a precondition may be omitted.

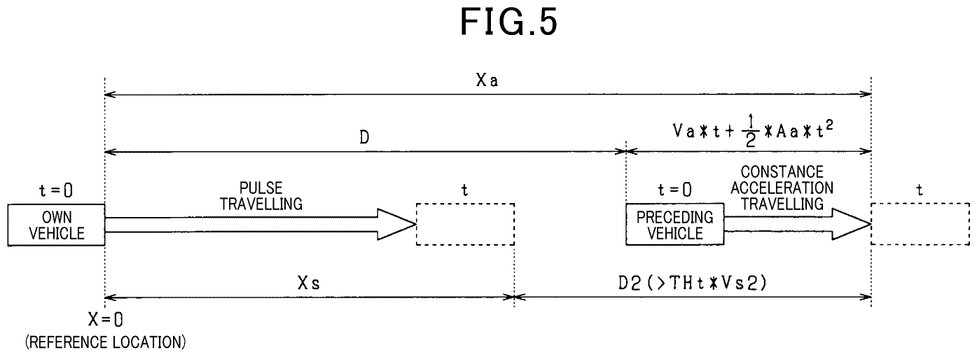

FIG. 5 is a schematic diagram illustrating a pulse mode start condition. FIG. 5 is similar to FIG. 3 except that the pulse mode travelling is executed instead of the coasting travelling, and the own vehicle acceleration As is an own vehicle acceleration As in the pulse mode (i.e. pulse acceleration Ap). Hence, the distance Xs is expressed as similar to the equation (1), and the distance Xa is expressed as similar to the equation (2).

For example, as a state where the coasting mode is executed, it may be assumed that the intervehicle distance D is shorter than the target intervehicle distance THd (=THt*Vs) and the own vehicle Vs is lower than the preceding vehicle speed Va. When the coasting mode continues to execute from that state for an excessively long period, there is a risk that intervehicle distance D is longer than the target intervehicle distance THd and the own vehicle speed Vs is excessively lower than the preceding vehicle speed Va. Hence, prior to that state, an appropriate timing for changing the mode from the coasting mode to the pulse mode may be present.

In this respect, the travelling control apparatus 70 determines a switch condition for switching the mode from the coasting mode to the pulse mode. The switch condition is satisfied in the case where the intervehicle distance D2 is longer than the target intervehicle distance THt*Vs2 at a coincide time (time t) where the preceding vehicle speed Va2 coincides with the own vehicle speed Vs2, when assuming that the pulse mode is executed from the current time point (t=0) during the coasting mode.

Then, the preceding vehicle speed Va2 at time t is expressed similar to the equation (3), the own vehicle speed Vs at time t is expressed similar to the equation (4) and the intervehicle distance D is expressed similar to the equation (5).

Therefore, the above-described condition for switching the mode from the coasting mode to the pulse mode is expressed by the following inequality (15).

$$THt * Vs 2 < D 2 \qquad ( 15 )$$

Similar to a case for switching the mode from the coasting mode to the pulse mode, the equation (7) is satisfied. The time t is expressed similar to the equation (8).

When substituting equations (4), (5), (2) and (1) in the inequality (15) and arranging the inequality using the relative speed Vr=(Va−Vs) at the time t=0, the following inequality (16) is obtained.

$$THt * \{ Vs - As * Vr / ( Aa - As ) \} < D - ( 1 / 2 ) * {Vr}^{2} / ( Aa - As ) \qquad ( 16 )$$

In the inequality (16), when arranging the inequality using Y=(left side)−(right side), the following inequality (17) is obtained.

$$Y = a * {Vr}^{2} + b * Vr + c < 0 \qquad ( 17 )$$

In the inequality (17), the future target intervehicle distance difference Y and coefficients a, b and c are similar to those in the case where the mode is changed to coasting mode to the pulse mode.

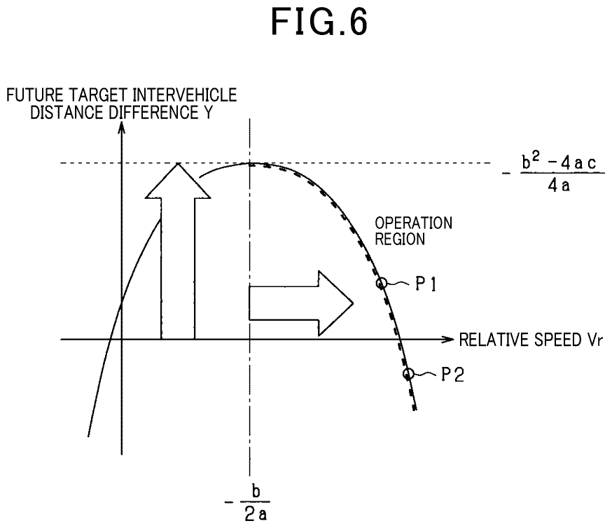

FIG. 6 shows a graph that plots Y where the horizontal axis is a relative speed Vr and the vertical axis Y is a future target intervehicle distance difference Y at the current time t=0. The graph Y indicates an amount of the future target intervehicle distance difference Y with respect to the current relative speed Vr when the preceding vehicle speed Va2 coincides with the own vehicle speed Vs2 after time t elapses. Hence, as long as the inequality (17) is satisfied with respect to the current relative speed Vr at the current time, the mode should be changed to the pulse mode from the coasting mode at the current time. For example, in the case where the current travelling state of the own vehicle 10 is at the point P1, since the inequality (17) is not satisfied, the coasting mode is continued to execute. On the other hand, when the travelling state of the own vehicle 10 is at the point P2, since the inequality (17) is satisfied, the mode is changed to the pulse mode from the coasting mode. In other words, when assuming that the pulse mode starts to be executed from the current time during the coasting mode, the travelling control apparatus 70 changes the mode to the coasting mode from the pulse mode, under a condition determined that the intervehicle distance D is longer than the target intervehicle distance THt*Vs2 (i.e. future target intervehicle distance difference Y<0) at a time t (speed coincidence point) where the preceding vehicle speed Va2 coincides with the own vehicle speed Vs2 based on the own vehicle speed Vs, the relative speed Vr, the intervehicle distance D, the own vehicle acceleration As (pulse acceleration Ap) and the preceding vehicle acceleration Aa. Note that the travelling control apparatus 70 determines whether the inequality (17) is satisfied with the preceding vehicle acceleration being Aa=0.

However, in order to determine whether a determination whether the mode is changed to the pulse mode from the coasting mode using the inequality (17) is appropriate for the assumed travelling states of the own vehicle 10 and the preceding vehicle, a precondition is further added which is a condition that the following inequalities (18) and (19) are satisfied.

$$Aa - As < 0 \qquad ( 18 )$$

The inequality (18) indicates that the own vehicle acceleration As in the pulse mode (pulse acceleration Ap) is larger than the preceding vehicle acceleration Aa. In the case where the inequality (18) is not satisfied, since the own vehicle speed Vs2 does not approach the preceding vehicle speed Va2 even if the pulse mode operation is executed (the own vehicle speed Vs2 does not increase to the preceding vehicle speed Va2), this is inappropriate for the assumed traveling states of the own vehicle 10 and the preceding vehicle. Hence, in this case, a determination whether the mode is changed to the pulse mode from the coasting mode is not performed. Alternatively, the apparatus determines that a condition for changing the mode from the coasting mode to the pulse mode is not satisfied. Since a case where the inequality (18) is satisfied equals a case where a coefficient a=(½)/(Aa−As) is negative, the graph shown in FIG. 6 has a convex shape upwardly.

$$- b / 2 a < Vr \qquad ( 19 )$$

The inequality (19) indicates that, in the graph indicating the future target intervehicle distance difference Y, the relative speed Vr is positioned in a right side operation region with respect to the center axis of the graph. As long as the relative speed Vr is in a left side region with respect to the center axis of the graph, the higher the relative speed Vr (higher preceding vehicle speed Va than the own vehicle speed Vs), the larger the future target intervehicle distance difference Y is (the intervehicle distance D2 is shorter than the target intervehicle distance THt*Vs2). Hence, this is inappropriate for assumed traveling states of the own vehicle 10 and the preceding vehicle. Therefore, in this case, the apparatus does not perform a determination whether the mode is changed to the pulse mode from the coasting mode using the inequality (17). Alternatively, the apparatus determines that a condition for changing the mode from the coasting mode to the pulse mode is not satisfied.

When substituting a coefficient a=(½)/(Aa−As) and a coefficient b=THt*{−Aa/(Aa−As)−1} in the inequality (19) and arranging the inequality, the following inequality (20) is obtained.

$$THt * Aa < Vr \qquad ( 20 )$$

In a state where the pulse mode or the coasting mode is executed, the preceding vehicle acceleration Aa is likely to be 0. Hence, the inequality (20) indicates that the current relative speed Vr is positive value. Assuming that the coasting mode is executed before changing the mode to be the pulse mode, when the inequality (20) is satisfied, it is inappropriate for the assumed travelling states of the own vehicle 10 and the preceding vehicle. That is, when the coasting mode is executed before changing the mode to be the pulse mode, the inequality (20) is normally satisfied. Therefore, the inequality (19) as a precondition, that is, the inequality (20) as a precondition, may be omitted.

In order to determine whether a determination whether the mode is changed to the pulse mode from the coasting mode using the inequality (17) is appropriate for the assumed travelling states of the own vehicle 10 and the preceding vehicle, a precondition is further added which is a condition that the following inequality (21) is satisfied.

$$- ( {b}^{2} - 4 a * c ) / 4 a > 0 \qquad ( 21 )$$

The inequality (21) indicates that the apex of the future target intervehicle distance difference Y plot in the graph is positive value.

In the case where the further target intervehicle distance difference Y plot in the graph has a convex shape upwardly and the apex of the plot in the graph has negative value, the future target intervehicle distance difference Y is a negative value (the intervehicle distance D2 is longer than the target intervehicle distance THt*Vs2) regardless of a magnitude of the current relative speed Vr. In this case, the coasting mode operation has not been executed (not continued to execute till the current time). Hence, this is inappropriate for the assumed traveling states of the own vehicle 10 and the preceding vehicle. In other words, when the coasting mode operation is executed before changing the mode to the pulse mode, the inequality (21) is usually satisfied. Therefore, the inequality (21) as a precondition may be omitted.

The present embodiment as described above in detail has the following effects and advantages.

The engine ECU 61 is configured to control the rotation speed and the output torque of the engine 11 in the pulse mode and the normal ACC mode. Hence, the engine ECU 61 recognizes the current rotation speed and the current output torque of the engine 11 (current operation state), the current transmission gear ratio of the transmission in the transmission intercepting mechanism 12 (current transmission state) and the like. Further, the engine ECU 61 includes information about characteristics of the engine 11, characteristics of the transmission intercepting mechanism 12 (transmission gear ratio of transmission), the vehicle weight of the own vehicle 10 and the like. Hence, the engine ECU 61 is able to calculate, based on the known characteristics of the engine 11, the known characteristics of the transmission intercepting mechanism 12, the current operation state of the engine 11 and the current transmission state of the transmission intercepting mechanism 12, the engine output power (unit: kw) when assuming that the pulse mode is executed. Then, the brake ECU 63 estimates the current control value in accordance with data stored in time series including a change in the wheel speed responding to the engine output, the detection value of the acceleration sensor 51, the current total vehicle weight taking the number of passengers and load capacity into consideration in accordance with the weight value estimated in the design process in advance, an amount of road surface resistance and the degree of slope. Also, the brake ECU 61 combines the estimated current control value with the engine output during the pulse mode calculated by the engine ECU 61, thereby calculating the pulse acceleration Ap accomplished by the own vehicle 10 during the pulse mode. Moreover, the engine output is assumed to be 0, thereby calculating the glide acceleration Ag accomplished by the own vehicle 10 during the coasting mode.

When assuming that the coasting mode starts to be executed from the current time during the pulse mode, the travelling control apparatus 70 changes the mode to the coasting mode from the pulse mode, under a condition determined that the intervehicle distance D is shorter than a predetermined target intervehicle distance THd(=THt*Vs2) at a time t (speed coincidence point) where the preceding vehicle speed Va2 coincides with the own vehicle speed Vs2 based on the received own vehicle speed Vs, the received relative speed Vr, the received intervehicle distance D, the received glide acceleration Ag and the calculated preceding vehicle acceleration Aa. Since the intervehicle distance D2 does not change when the own vehicle speed Vs2 after time t elapses coincides with the preceding vehicle speed Va2 after time t elapses, with this state, if the intervehicle distance D2 becomes shorter than the target intervehicle distance THt*Vs2, the mode should be changed to the coasting mode from the current time (current state). Hence, when changing the mode from the pulse mode to the coasting mode with a condition determined as described above, the mode can be changed to the coasting mode from the pulse mode at an appropriate timing. Further, the travelling control apparatus 70 receives the pulse acceleration Ap and the glide acceleration Ag which are calculated by the engine ECU 61 and utilizes them for determination of the mode change. Hence, there is no need to estimate the pulse acceleration Ap and the glide acceleration Ag in advance.

The travelling control apparatus 70 changes the mode from the pulse mode to the coasting mode under a condition that the inequality (10) is satisfied. According to the above-described configuration, since the conditions can be simply defined with a quadratic inequality of the current relative speed Vr, a calculation load of the travelling control apparatus 70 can be mitigated.

The travelling control apparatus 70 changes the mode to the coasting mode from the pulse mode under a condition determined that the THt*Aa>Vr in addition to a condition that the inequality (10) is satisfied. According to the above-described configuration, as a state where the inequality (10) is satisfied, it is determined that the current relative speed Vr where the own vehicle speed Vs is subtracted from the current preceding vehicle speed Va is not high, that is, the own vehicle 10 executes the pulse mode before changing the mode. Hence, the mode can be appropriately changed to the coasting mode from the pulse mode.

In other words, when assuming that the pulse mode starts to be executed from the current time during the coasting mode, the travelling control apparatus 70 changes the mode to the pulse mode from the glide, under a condition determined that the intervehicle distance D is longer than the target intervehicle distance THd(=Tht*Vs2) at a time t (speed coincidence point) where the preceding vehicle speed Va2 coincides with the own vehicle speed Vs2 based on the received own vehicle speed Vs, the received relative speed Vr, the received intervehicle distance D, the received pulse acceleration Ap and the calculated preceding vehicle acceleration Aa. Since the intervehicle distance D2 does not change when the own vehicle speed Vs2 after time t elapses coincides with the preceding vehicle speed Va2 after time t elapses, with this state, if the intervehicle distance D2 becomes longer than the target intervehicle distance THt*Vs2, the mode should be changed to the pulse mode from the current time. Hence, when changing the mode from the coasting mode to the pulse mode with a condition determined as described above, the mode can be changed to the pulse mode from the coasting mode at an appropriate timing. Further, the travelling control apparatus 70 receives the pulse acceleration Ap and the glide acceleration Ag which are calculated by the brake ECU 63 and utilizes them for determination of the mode change. Hence, there is no need to estimate the pulse acceleration Ap and the glide acceleration Ag in advance.

The travelling control apparatus 70 changes the mode from the coasting mode to the pulse mode under a condition that the inequality (17) is satisfied. According to the above-described configuration, since the conditions can be simply defined with a quadratic inequality of the current relative speed Vr, a calculation load of the travelling control apparatus 70 can be mitigated.

The travelling control apparatus 70 changes the mode to the pulse mode from the coasting mode under a condition determined that the THt*Aa>Vr in addition to a condition that the inequality (17) is satisfied. According to the above-described configuration, as a state where the inequality (17) is satisfied, it is determined that the current relative speed Vr where the own vehicle speed Vs is subtracted from the current preceding vehicle speed Va is not low, that is, the own vehicle 10 executes the coasting mode before changing the mode. Hence, the mode can be appropriately changed to the pulse mode from the coasting mode.

The external field information detection apparatus 30 (distance detection unit) detects an intervehicle distance D which is a distance between the own vehicle 10 and the preceding vehicle. The external field information detection apparatus 30 (relative speed detection unit) divides an amount of change in the detected intervehicle distance D by a time of the change or differentiates the intervehicle distance D, thereby detecting (calculating) a relative speed Vr between the preceding vehicle and the own vehicle 10.

In the case where the preceding vehicle acceleration Aa is calculated based on the relative speed Vr acquired in accordance with the differential value of the intervehicle distance D detected by the external field information detection apparatus 30, there is a risk that the accuracy of the preceding vehicle acceleration Aa may be lowered. In this respect, the travelling control apparatus 70 performs a determination with the preceding vehicle acceleration Aa being 0. Hence, in the case where there is a risk that the accuracy of the preceding vehicle acceleration Aa may be lowered, the preceding vehicle acceleration Aa can be appropriately calculated. Moreover, the mode can be changed between the pulse mode and the coasting mode at an appropriate timing. Note that the preceding vehicle acceleration Aa can be calculated in accordance with the relative speed Vr based on the differential value of the intervehicle distance D detected by the external field information detection apparatus 30, without setting the preceding vehicle acceleration Aa to be 0.

Since the slope of the road on which the own vehicle 10 travels changes depending on the actual travelling environment, the slope of the road cannot be estimated in advance. In this regard, the travelling control apparatus 70 uses a slope calculated by the brake ECU 63 to determine whether the mode is changed between the pulse mode and the coasting mode. Hence, the travelling control apparatus 70 is able to appropriately change the mode between the pulse mode and the coasting mode depending on an actual slope of the road on which the own vehicle travels. Note that the travelling control apparatus 70 may further utilize a state of the road surface of the road (travelling road) received (acquired) from the brake ECU 63, thereby determining whether the mode is changed between the pulse mode and the coasting mode.

The above-described embodiments may be modified in the following manners. For configurations similar to those in the above-described embodiments, the same reference symbols are applied and the explanation thereof will be applied.

The target intervehicle distance THd may be set to be a constant value (fixed value) regardless of the own vehicle Vs.

The slope information may be acquired by a slope sensor 52 (see FIG. 1) mounted on the own vehicle 10 or may be acquired by combining slope information included in the map information stored in the navigation system with the location of the own vehicle on the map. Moreover, slope information may be acquired from a road facility via a road-vehicle communication.

The intervehicle communication apparatus 40 communicates with the preceding vehicle to transmit/receive information with each other. The information includes a preceding vehicle acceleration Aa as an acceleration factor of the preceding vehicle. The preceding vehicle acceleration Aa is calculated using the preceding vehicle speed Va detected by the wheel speed sensor included in the preceding vehicle or is detected by the acceleration sensor of the preceding vehicle. The accuracy of the preceding vehicle acceleration Aa thus detected is higher than the accuracy of the preceding vehicle acceleration Aa calculated based on the intervehicle distance D detected by the external field information detection apparatus 30. In this respect, when the own vehicle 10 is able to acquire the preceding vehicle acceleration Aa from the preceding vehicle via the intervehicle communication, the traveling control apparatus 70 may acquire the preceding vehicle acceleration Aa from the preceding vehicle to perform a determination process. When the own vehicle 10 is unable to acquire the preceding vehicle acceleration Aa from the preceding vehicle, the traveling control apparatus 70 may set the preceding vehicle acceleration to be 0 and perform a determination of the condition. According to such a configuration, in the case where the preceding vehicle acceleration Aa having high accuracy is available, a determination of the mode change can be performed using the acquired preceding vehicle acceleration Aa. On the other hand, when there is a risk that the accuracy of the preceding vehicle acceleration Aa is lowered, the preceding vehicle acceleration Aa may be set to be 0, whereby the preceding vehicle acceleration Aa can be appropriately calculated.

The intervehicle communication apparatus 40 performs communication with the preceding vehicle to exchange information. When the information includes a preceding vehicle speed Va as a travelling speed of the preceding vehicle Va, the relative speed Vr can be detected (calculated) in the following manner. That is, the travelling control apparatus 70 (relative speed detection unit) may subtract the own vehicle speed Vs from the preceding vehicle speed Va, thereby calculating the relative speed Vr(Vr=Va−Vs).

When assuming that the coasting mode is executed from the current time during the pulse mode being executed, the own vehicle acceleration As in the coasting mode (glide acceleration Ag) may be assumed to change at an own vehicle jerk AAs. The own vehicle jerk AAs refers to a change rate of the own vehicle acceleration As which is detected (calculated) by dividing an amount of change in the own vehicle acceleration As by the change time, or differentiating the own vehicle acceleration As. When assuming that the coasting mode is executed from the current time during the pulse mode being executed, the preceding vehicle acceleration Aa may be assumed to change at a preceding vehicle jerk AAa. The preceding vehicle AAa refers to a change rate of the preceding vehicle acceleration Aa which is detected (calculated) by dividing an amount of change in the preceding vehicle acceleration Aa by the change time, or differentiating the preceding vehicle acceleration As. Similarly, when assuming that the pulse mode is executed from the current time during the coasting mode being executed, the own vehicle acceleration As in the pulse mode (pulse acceleration Ap) may be assumed to change at an own vehicle jerk AAs. When assuming that the pulse mode is executed from the current time during the coasting mode being executed, the preceding vehicle acceleration Aa may be assumed to change at the preceding vehicle jerk AAa.

The travelling control apparatus 70 may execute, when causing the own vehicle 10 to follow other vehicle, a traveling mode other than the pulse mode, the coasting mode and the normal ACC mode. For example, the traveling control apparatus 70 is also capable of executing a hybrid mode in which the own vehicle 10 travels with the engine 11 and the motor 13 as driving sources and an EV mode in which the own vehicle travels only with the motor 13 as a driving source. Even in the case where the travelling mode of the own vehicle 10 includes these travelling modes, the travelling control apparatus 70 may change the mode with the conditions described in the above embodiments, when causing the own vehicle 10 to travel changing the mode between the pulse mode and the coasting mode.

The motor 13 and the ECU 62 may be omitted. That is, the own vehicle 10 may be provided with the engine 11 only as a driving source.

It is noted that the above-described embodiments and respective modification examples may be combined and embodied as long as the combination is possible.

### CONCLUSION

The present disclosure provides a technique utilized in a travelling control apparatus of a vehicle for appropriately changing a plurality of control modes without assuming an acceleration of each control mode in advance.

As a first aspect of the present disclosure, a travelling control apparatus is provided which is installed in an own vehicle provided with an engine, a driving wheel and a transmission intercepting mechanism that transmits and cuts off a driving force between the engine and the driving wheel, causing the own vehicle to follow a preceding vehicle,
wherein the own vehicle includes:
an own vehicle speed detection unit that detects an own vehicle speed as a travelling speed of the own vehicle;
a relative speed detection unit that detects a relative speed between the preceding vehicle and the own vehicle;
a distance detection unit that detects an intervehicle distance between the preceding vehicle and the own vehicle;
a slope calculation unit that calculates a slope of a travelling road on which the own vehicle travels; and
an engine ECU that controls the engine.

The travelling control apparatus is configured to execute a travelling mode between a pulse mode and a coasting mode, the pulse mode operating the engine at a predetermined operation region where a heat efficiency is the highest to cause the own vehicle to travel, the coasting mode stopping the engine to cause the own vehicle to perform a coasting travel in a state where the transmission intercepting mechanism cuts off the driving force;
the engine ECU is configured to calculate an output of the engine in accordance with a known characteristics of the engine and a current operation state of the engine;
the slope calculation unit is configured to calculate, in accordance with the output of the engine calculated by the engine ECU, a known weight of the own vehicle and the calculated slope, a pulse acceleration as an acceleration of the own vehicle when assuming that the pulse mode is executed and a glide acceleration as an acceleration of the own vehicle when assuming that the coasting mode is executed;
the travelling control apparatus is configured to acquire the own vehicle speed detected by the own vehicle speed detection unit, the relative speed detected by the relative speed detection unit, the intervehicle distance detected by the distance detection unit, the pulse acceleration and the glide acceleration which are calculated by the slope calculation unit; and
the travelling control apparatus is configured to, when assuming that the coasting mode starts to be executed from a current time during the pulse mode, change the travelling mode to the coasting mode from the pulse mode, under a condition determined that the intervehicle distance is shorter than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired glide acceleration and a preceding vehicle acceleration as an acceleration of the preceding vehicle which is acquired or calculated.

According to the above-described configurations, the own vehicle detection unit detects the own vehicle speed, the relative speed detection unit detects a relative speed between the preceding vehicle and the own vehicle, the distance detection unit detects an intervehicle distance and the slope calculation unit calculates a slope of the travelling road. That is, the own vehicle is provided with detection units and calculation units for detecting the traveling state of the own vehicle, a relationship of the traveling states between the own vehicle and other vehicle and the travelling environment of the own vehicle. Then, the engine ECU controls the engine. Note that the relative speed between the preceding vehicle and the own vehicle is a speed in which the own vehicle speed is subtracted from the preceding vehicle speed as a speed of the preceding vehicle.

The traveling control apparatus is able to change (switch) the traveling mode between the pulse mode and the coasting mode. In the pulse mode, the own vehicle usually approaches other vehicle. In the coasting mode, the own vehicle usually departs from other vehicle. Hence, the traveling control apparatus performs a control changing the traveling mode between the pulse mode and the coasting mode. Hence, the own vehicle is caused to follow the preceding vehicle (following travel).

Since the engine ECU controls the engine, the engine ECU recognizes the engine rotation speed and the output torque thereof (operation state). Hence, the engine ECU is capable of calculating the output of the engine (engine output) based on the known characteristics of the engine and the current operation state of the engine. Then, the slope calculation unit is able to appropriately calculate, in accordance with the calculated engine output, the known weight of the own vehicle and the calculated slope, the pulse acceleration when assuming that the pulse mode is executed and the glide acceleration when assuming that the coasting mode is executed.

For example, as a state where the pulse mode is executed, it can be assumed that the intervehicle distance is longer than the predetermines target intervehicle distance and the own vehicle speed is higher than the preceding vehicle speed. When a period for executing the pulse mode is excessively long from that state, there is a risk that the intervehicle distance becomes shorter than the target intervehicle distance, and the own vehicle speed becomes excessively high. Hence, it is considered that an appropriate timing is present prior to the above-described state for changing the traveling mode from the pulse mode to the coasting mode.

In this respect, the travelling control apparatus is configured to, when assuming that the coasting mode starts to be executed from a current time during the pulse mode, change the travelling mode to the coasting mode from the pulse mode, under a condition determined that the intervehicle distance is shorter than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired glide acceleration and a preceding vehicle acceleration as an acceleration of the preceding vehicle which is acquired or calculated. That is, since the intervehicle distance does not change when the own vehicle speed coincides with the preceding vehicle speed, with this state, if the intervehicle distance becomes shorter than the target intervehicle distance, the travelling mode should be changed to the coasting mode from the current time (current state). Therefore, with a condition determined as described above, when changing the traveling mode to the coasting mode from the pulse mode, the traveling mode can be changed to the coasting mode from the pulse mode at an appropriate timing. Further, since the travelling control apparatus acquires the pulse acceleration and the glide acceleration calculated by the slope calculation unit and utilizes them for determining the mode change, it is not necessary to estimate the pulse acceleration and the glide acceleration.

As a second aspect, the travelling control apparatus changes the travelling mode from the pulse mode to the coasting mode when determining that the condition of a following equation is satisfied:

$$THt * \{ Vs - Ag * Vr / ( Aa - Ag ) \} > D - ( 1 / 2 ) * ( {Vr}^{2} ) / ( Aa - Ag ) and \\ Aa - Ag > 0 ,$$

where THt is a predetermined target intervehicle time, Vs is the own vehicle speed, Ag is the glide acceleration, Vr is the relative speed, Aa is the preceding vehicle acceleration, D is the intervehicle distance.

According to the above-described configuration, with a quadratic inequality of the relative speed Vr, the above-described condition can be simply defined. Hence, the processing load of the travelling control apparatus can be mitigated. Note that the predetermined target intervehicle time THt refers to a time where the target intervehicle distance which is set such that the higher the own vehicle distance, the longer the target intervehicle distance, is divided by the own vehicle speed. The predetermined target intervehicle time THt can be set in advance. Note that * refers to multiplication, / refers to a division and Vr² refers to a square of Vr.

As a third aspect, the traveling control apparatus changes the traveling mode to the coasting mode from the pulse mode when determining that a condition of a following equation is satisfied:

$$THt * Aa > Vr .$$

According to the above-described configuration, as a state where the above-described inequality is satisfied, it is determined that the current relative speed where the own vehicle speed is subtracted from the current preceding vehicle speed is not high, that is, the own vehicle executes the pulse mode before changing the mode. Hence, the mode can be appropriately changed to the coasting mode from the pulse mode.

As a fourth aspect, a travelling control apparatus is provided which is installed in an own vehicle provided with an engine, a driving wheel and a transmission intercepting mechanism that transmits and cuts off a driving force between the engine and the driving wheel, causing the own vehicle to follow a preceding vehicle, wherein
the own vehicle includes:
an own vehicle speed detection unit that detects an own vehicle speed as a travelling speed of the own vehicle;
a relative speed detection unit that detects a relative speed between the preceding vehicle and the own vehicle;
a distance detection unit that detects an intervehicle distance between the preceding vehicle and the own vehicle;
a slope calculation unit that calculates a slope of a travelling road on which the own vehicle travels; and
an engine ECU that controls the engine.

The travelling control apparatus is configured to execute a travelling mode between a pulse mode and a coasting mode, the pulse mode operating the engine at a predetermined operation region where a heat efficiency is the highest to cause the own vehicle to travel, the coasting mode stopping the engine to cause the own vehicle to perform a coasting travel in a state where the transmission intercepting mechanism cuts off the driving force;
the engine ECU is configured to calculate an output of the engine in accordance with a known characteristics of the engine and a current operation state of the engine;
the slope calculation unit is configured to calculate, in accordance with the output of the engine calculated by the engine ECU, a known weight of the own vehicle and the calculated slope, a pulse acceleration as an acceleration of the own vehicle when assuming that the pulse mode is executed and a glide acceleration as an acceleration of the own vehicle when assuming that the coasting mode is executed;
the travelling control apparatus is configured to acquire the own vehicle speed detected by the own vehicle speed detection unit, the relative speed detected by the relative speed detection unit, the intervehicle distance detected by the distance detection unit, the pulse acceleration and the glide acceleration which are calculated by the slope calculation unit; and
the travelling control apparatus is configured to, when assuming that the pulse mode starts to be executed from a current time during the coasting mode, change the travelling mode to the pulse mode from the coasting mode, under a condition determined that the intervehicle distance is longer than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired pulse acceleration and a preceding vehicle acceleration as an acceleration of the preceding vehicle which is acquired or calculated.

For example, as a state where the coasting mode is executed, it may be assumed that the intervehicle distance is shorter than the target intervehicle distance and the own vehicle is lower than the preceding vehicle speed. When the coasting mode continues to execute from that state for an excessively long period, there is a risk that intervehicle distance is longer than the target intervehicle distance and the own vehicle speed is excessively lower than the preceding vehicle speed. Hence, prior to that state, an appropriate timing for changing the mode from the coasting mode to the pulse mode may be present.

In this respect, the travelling control apparatus is configured to, when assuming that the pulse mode starts to be executed from a current time during the coasting mode, change the travelling mode to the pulse mode from the coasting mode, under a condition determined that the intervehicle distance is longer than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired pulse acceleration and a preceding vehicle acceleration as an acceleration of the preceding vehicle which is acquired or calculated. That is, since the intervehicle distance does not change when the own vehicle speed coincides with the preceding vehicle speed, with this state, if the intervehicle distance becomes longer than the target intervehicle distance, the travelling mode should be changed to the pulse mode from the current time (current state). Therefore, with a condition determined as described above, when changing the traveling mode to the pulse mode from the coasting mode, the traveling mode can be changed to the coasting mode from the pulse mode at an appropriate timing. Further, since the travelling control apparatus acquires the pulse acceleration and the glide acceleration calculated by the slope calculation unit and utilizes them for determining the mode change, it is not necessary to estimate the pulse acceleration and the glide acceleration.

As a fifth aspect, the travelling control apparatus changes the travelling mode from the coasting mode to the pulse mode when determining that the condition of a following equation is satisfied:

$$THt * \{ Vs - Ap * Vr / ( Aa - Ap ) \} < D - ( 1 / 2 ) * ( {Vr}^{2} ) / ( Aa - Ap ) and \\ Aa - Ap < 0 ,$$

where THt is a predetermined target intervehicle time, Vs is the own vehicle speed, Ap is the pulse acceleration, Vr is the relative speed, Aa is the preceding vehicle acceleration, D is the intervehicle distance.

According to the above-described configuration, with a quadratic inequality of the relative speed, the above-described condition can be simply defined. Hence, the processing load of the travelling control apparatus can be mitigated.

As a sixth aspect, the traveling control apparatus changes the traveling mode to the pulse mode from the coasting mode when determining that a condition of a following equation is further satisfied:

$$THt * Aa > Vr .$$

According to the above-described configuration, as a state where the above-described inequality is satisfied, it is determined that the own vehicle speed is subtracted from the preceding vehicle speed is not low, that is, the own vehicle executes the coasting mode before changing the mode. Hence, the traveling mode can be appropriately changed to the pulse mode from the coasting mode.

In the case where the preceding vehicle acceleration is calculated in accordance with the differential value of the intervehicle distance detected by the distance detection apparatus, there is a risk that the accuracy of the preceding vehicle acceleration may be lowered. In this case, when determining the mode change using a low-accuracy preceding vehicle acceleration, the mode may not be changed between the pulse mode and the coasting mode at an appropriate timing. On the other hand, generally, when causing the own vehicle to follow the preceding vehicle, the preceding vehicle and the own vehicle may often travel on an express way or a major road having less signals. In this case, since the preceding vehicle likely to travel at a constant speed, when determining the preceding vehicle acceleration to be 0 rather than calculating the preceding vehicle acceleration in accordance with the differential value of the intervehicle distance, the accuracy of the preceding vehicle acceleration may be higher.

In this respect, as a seventh aspect, the traveling control apparatus performs a determination of the condition using the preceding vehicle acceleration being 0. Hence, even when there is a risk that the preceding vehicle acceleration is lowered, the preceding vehicle acceleration can be appropriately calculated. Further, the travelling mode can be changed between the pulse mode and the coasting mode at an appropriate timing.

Generally, the preceding vehicle is provided with a vehicle speed sensor that detects a travelling speed of the preceding vehicle. Accordingly, the preceding vehicle acceleration can be accurately calculated based on the preceding vehicle speed detected by the vehicle wheel sensor.

In this respect, as an eighth aspect, when the own vehicle is able to acquire the preceding vehicle acceleration from the preceding vehicle via an intervehicle communication, the traveling control apparatus acquires the preceding vehicle acceleration from the preceding vehicle to perform a determination of the condition; and
when the own vehicle is unable to acquire the preceding vehicle acceleration from the preceding vehicle, the traveling control apparatus sets the preceding vehicle acceleration to be 0 and performs the determination of the condition. According to this configuration, in the case where the preceding vehicle acceleration having high accuracy is available, a determination of the mode change can be performed using the acquired preceding vehicle acceleration. On the other hand, when there is a risk that the accuracy of the preceding vehicle acceleration is lowered, the preceding vehicle acceleration may be set to be 0, whereby the preceding vehicle acceleration can be appropriately calculated.

What is claimed is:

1. A travelling control apparatus installed in an own vehicle provided with an engine, a driving wheel and a transmission intercepting mechanism that transmits and cuts off a driving force between the engine and the driving wheel, causing the own vehicle to follow a preceding vehicle, wherein
the own vehicle comprising:
an own vehicle speed detection unit that detects an own vehicle speed as a travelling speed of the own vehicle;
a relative speed detection unit that detects a relative speed between the preceding vehicle and the own vehicle;
a distance detection unit that detects an intervehicle distance between the preceding vehicle and the own vehicle;
a slope calculation unit that calculates a slope of a travelling road on which the own vehicle travels; and
an engine ECU that controls the engine,
wherein
the travelling control apparatus is configured to execute a travelling mode between a pulse mode and a coasting mode, the pulse mode operating the engine at a predetermined operation region where a heat efficiency is the highest to cause the own vehicle to travel, the coasting mode stopping the engine to cause the own vehicle to perform a coasting travel in a state where the transmission intercepting mechanism cuts off the driving force;
the engine ECU is configured to calculate an output of the engine in accordance with a known characteristics of the engine and a current operation state of the engine;
the slope calculation unit is configured to calculate, in accordance with the output of the engine calculated by the engine ECU, a known weight of the own vehicle and the calculated slope, a pulse acceleration as an acceleration of the own vehicle when assuming that the pulse mode is executed and a glide acceleration as an acceleration of the own vehicle when assuming that the coasting mode is executed;
the travelling control apparatus is configured to acquire the own vehicle speed detected by the own vehicle speed detection unit, the relative speed detected by the relative speed detection unit, the intervehicle distance detected by the distance detection unit, the pulse acceleration and the glide acceleration which are calculated by the slope calculation unit; and
the travelling control apparatus is configured to, when assuming that the coasting mode starts to be executed from a current time during the pulse mode, change the travelling mode to the coasting mode from the pulse mode, under a condition determined that the intervehicle distance is shorter than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired glide acceleration and a preceding vehicle acceleration as an acceleration of the preceding vehicle which is acquired or calculated.

2. The travelling control apparatus according to claim 1,
wherein
the travelling control apparatus changes the travelling mode from the pulse mode to the coasting mode when determining that the condition of a following equation is satisfied:
$$THt * \{ Vs - Ag * Vr / ( Aa - Ag ) \} > D - ( 1 / 2 ) * ( {Vr}^{2} ) / ( Aa - Ag ) and \\ Aa - Ag > 0 ,$$
where THt is a predetermined target intervehicle time, Vs is the own vehicle speed, Ag is the glide acceleration, Vr is the relative speed, Aa is the preceding vehicle acceleration, D is the intervehicle distance.

3. The traveling control apparatus according to claim 2,
wherein
the traveling control apparatus changes the traveling mode to the coasting mode from the pulse mode when determining that a condition of a following equation is further satisfied:
$$THt * Aa > Vr .$$

4. A travelling control apparatus installed in an own vehicle provided with an engine, a driving wheel and a transmission intercepting mechanism that transmits and cuts off a driving force between the engine and the driving wheel, causing the own vehicle to follow a preceding vehicle, wherein
the own vehicle comprising:
an own vehicle speed detection unit that detects an own vehicle speed as a travelling speed of the own vehicle;
a relative speed detection unit that detects a relative speed between the preceding vehicle and the own vehicle;
a distance detection unit that detects an intervehicle distance between the preceding vehicle and the own vehicle;
a slope calculation unit that calculates a slope of a travelling road on which the own vehicle travels; and
an engine ECU that controls the engine,
wherein
the travelling control apparatus is configured to execute a travelling mode between a pulse mode and a coasting mode, the pulse mode operating the engine at a predetermined operation region where a heat efficiency is the highest to cause the own vehicle to travel, the coasting mode stopping the engine to cause the own vehicle to perform a coasting travel in a state where the transmission intercepting mechanism cuts off the driving force;
the engine ECU is configured to calculate an output of the engine in accordance with a known characteristics of the engine and a current operation state of the engine;
the slope calculation unit is configured to calculate, in accordance with the output of the engine calculated by the engine ECU, a known weight of the own vehicle and the calculated slope, a pulse acceleration as an acceleration of the own vehicle when assuming that the pulse mode is executed and a glide acceleration as an acceleration of the own vehicle when assuming that the coasting mode is executed;
the travelling control apparatus is configured to acquire the own vehicle speed detected by the own vehicle speed detection unit, the relative speed detected by the relative speed detection unit, the intervehicle distance detected by the distance detection unit, the pulse acceleration and the glide acceleration which are calculated by the slope calculation unit; and
the travelling control apparatus is configured to, when assuming that the pulse mode starts to be executed from a current time during the coasting mode, change the travelling mode to the pulse mode from the coasting mode, under a condition determined that the intervehicle distance is longer than a predetermined target intervehicle distance at a speed coincidence point where a preceding vehicle speed as a travelling speed of the preceding vehicle coincides with the own vehicle speed, based on the acquired own vehicle speed, the acquired relative speed, the acquired intervehicle distance, the acquired pulse acceleration and a preceding vehicle acceleration as an acceleration of the preceding vehicle which is acquired or calculated.

5. The travelling control apparatus according to claim 4,
wherein
the travelling control apparatus changes the travelling mode from the coasting mode to the pulse mode when determining that the condition of a following equation is satisfied:
$$THt * \{ Vs - Ap * Vr / ( Aa - Ap ) \} < D - ( 1 / 2 ) * ( {Vr}^{2} ) / ( Aa - Ap ) and \\ Aa - Ap < 0 ,$$
where THt is a predetermined target intervehicle time, Vs is the own vehicle speed, Ap is the pulse acceleration, Vr is the relative speed, Aa is the preceding vehicle acceleration, D is the intervehicle distance.

6. The traveling control apparatus according to claim 5,
wherein
the traveling control apparatus changes the traveling mode to the pulse mode from the coasting mode when determining that a condition of a following equation is further satisfied:
$$THt * Aa > Vr .$$

7. The traveling control apparatus according to claim 1,
wherein
the traveling control apparatus performs a determination of the condition using the preceding vehicle acceleration being 0.

8. The traveling control apparatus according to claim 1,
wherein
when the own vehicle is able to acquire the preceding vehicle acceleration from the preceding vehicle via an intervehicle communication, the traveling control apparatus acquires the preceding vehicle acceleration from the preceding vehicle to perform a determination of the condition; and
when the own vehicle is unable to acquire the preceding vehicle acceleration from the preceding vehicle, the traveling control apparatus sets the preceding vehicle acceleration to be 0 and performs the determination of the condition.
